(19) United States
(12) Patent Application Publication
(10) Pub. No.: US 2021/0295375 A1
(43) Pub. Date: Sep. 23, 2021

(54) PREDICTION OF ATTENTIVENESS LEVELS FOR PRESENTATION OF ADVERTISEMENTS

(71) Applicant: AT&T Intellectual Property I, L.P., Atlanta, GA (US)

(72) Inventors: Anna Lidzba, Atlanta, GA (US); Nigel Bradley, Canton, GA (US); James Carlton Bedingfield, SR., Gainesville, GA (US); Alexander MacDougall, Newnan, GA (US); Ari Craine, Marietta, GA (US); Robert Koch, Norcross, GA (US)

(73) Assignee: AT&T Intellectual Property I, L.P., Atlanta, GA (US)

(21) Appl. No.: 16/825,699

(22) Filed: Mar. 20, 2020

(51) Int. Cl. G06Q 30/02; G06F 3/0481

(52) U.S. Cl. CPC G06Q 30/0244; G06F 3/04812; G06Q 30/0271; G06Q 30/0267

(57) ABSTRACT

Aspects of the subject disclosure may include, for example, receiving, from a client device, over a network, information about activities of an individual associated with the client device and predicting a relative ability to interact with content for the individual associated with client device. The relative ability to interact with content indicates an ability of the individual for receiving additional information that may be presented to the individual. The subject disclosure further includes comparing the relative ability to interact with content with a predetermined interaction threshold and, based on the comparing, selecting one or more items of information to present to the individual. The subject disclosure further includes communicating the one or more items of information to the client device. Other embodiments are disclosed.

### FIELD OF THE DISCLOSURE

The subject disclosure relates to a prediction of an ability to interact with content by a user or predict attentiveness levels of a user for presentation of advertisements.

### BACKGROUND

It is common to send content over a network to an individual. Such content may include messages, content feeds and advertising. The individual may have access to one or more devices that allow consumption of such content, either at a fixed location or in a mobile environment. However, not all times and places are convenient for receipt of content by the individual.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating a first example, non-limiting embodiment of a system for predicting ability of a user to interact with presented content such as advertising and functioning within the communication network of FIG. 1 in accordance with various aspects described herein.

FIG. 2B depicts a second exemplary, non-limiting embodiment of a system for predicting ability of a user to interact with presented content such as advertising and functioning within the communication network of FIG. 1 in accordance with various aspects described herein.

FIG. 2C is a flow diagram illustrating an exemplary, non-limiting embodiment of a method of operation of a client device in the system of FIG. 2A or FIG. 2B in accordance with various aspects described herein.

FIG. 2D is a flow diagram illustrating an exemplary, non-limiting embodiment of a method of operation of a network device in the system of FIG. 2A or FIG. 2B in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for determining a best time and location for delivering an advertisement to an individual or other party, as well as a best channel or means for presenting the advertisement to the individual or other party. Other embodiments are described in the subject disclosure.

One or more aspects of the subject disclosure include receiving, from a client device, over a network, information about activities of an individual associated with the client device and predicting a relative ability to interact with content for the individual associated with client device. The relative ability to interact with content indicates an ability of the individual for receiving additional information that may be presented to the individual. The subject disclosure further includes comparing the relative ability to interact with content with a predetermined interaction threshold and, based on the comparing, selecting one or more items of information to present to the individual. The subject disclosure further includes communicating the one or more items of information to the client device.

One or more aspects of the subject disclosure include receiving, by a processing system including a processor, information about current and future activities of an individual associated with a client device and determining a current relative ability to interact with content and a future relative ability to interact with content for the individual. The determining may be based on the information about current and future activities of the individual. The subject disclosure may further include determining an item of information to present to the individual at a user device associated with the individual based on the information about current and future activities of the individual and determining a preferred time to present the item of information to the individual. Determining the preferred time may be based on the information about current and future activities of the individual. The subject disclosure further includes determining a preferred mode to present the item of information to the individual based on the information about current and future activities of the individual and communicating information about the item of information, the preferred time and the preferred mode to a server for communication to the individual.

One or more aspects of the subject disclosure include storing information about location and activities of an individual based on a usage of client devices by the individual and predicting a relative ability to interact with content for the individual. The relative ability to interact with content corresponds to an ability of the individual to receive and interact with information to be presented to the individual through the one or more client devices. The subject disclosure further includes selecting an item of information, a presentation time and a presentation mode for presenting the item of information to the individual based on the relative ability to interact with content, and communicating information about the item of information, the presentation time and the presentation mode to the client devices to control presentation of the item of information to the individual.

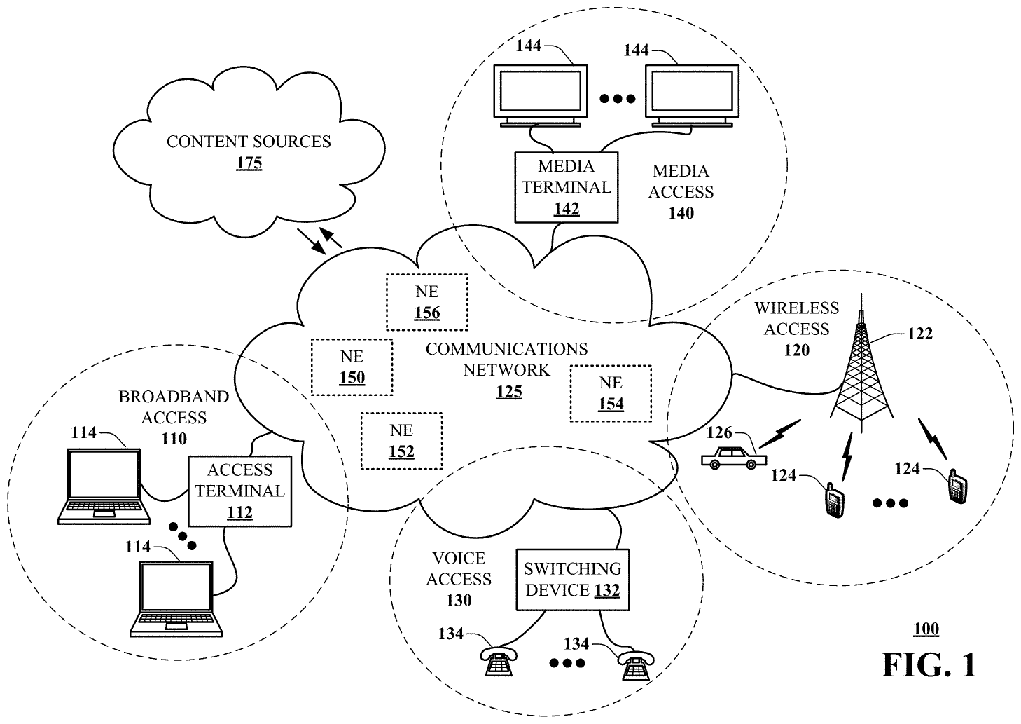

Referring now to FIG. 1, a block diagram is shown illustrating an example, non-limiting embodiment of a system 100 in accordance with various aspects described herein. For example, system 100 can facilitate in whole or in part communicating user data about location and activities of a user operating, for example, a data terminal 114, a mobile device 124 or a telephony device 134, and determining, at a network element, a prediction of attentiveness of the user, or the ability of the user to interact with content presently or in the future. The activities of the user may be electronic in nature, such as watching a streaming video or purchasing a product using an electronic device. Moreover, the activities of the user may be non-electronic activities, such as events scheduled using a calendar of the electronic device or movements of the user tracked by a location finding function of the electronic device. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

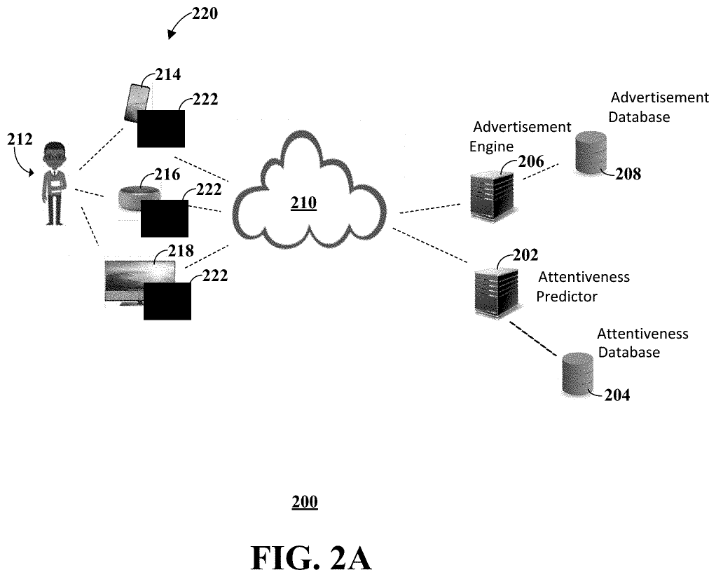

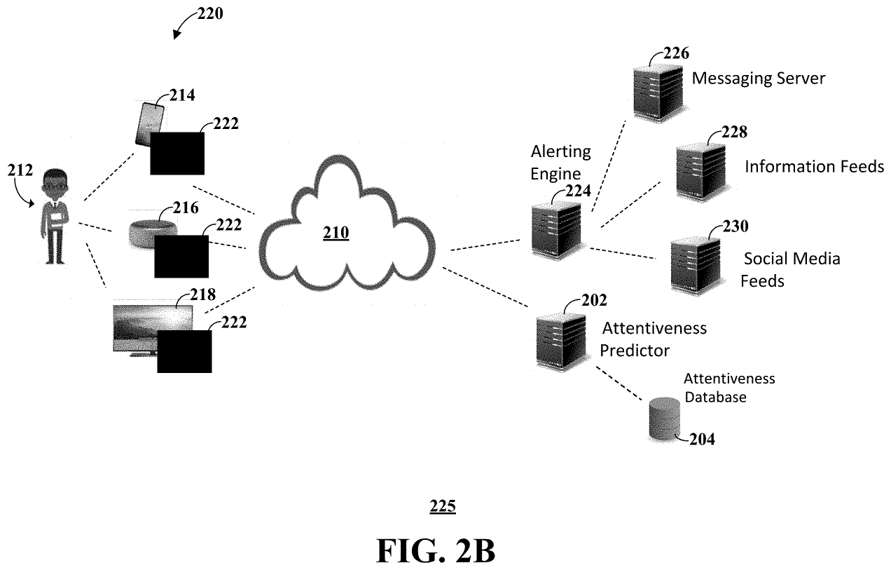

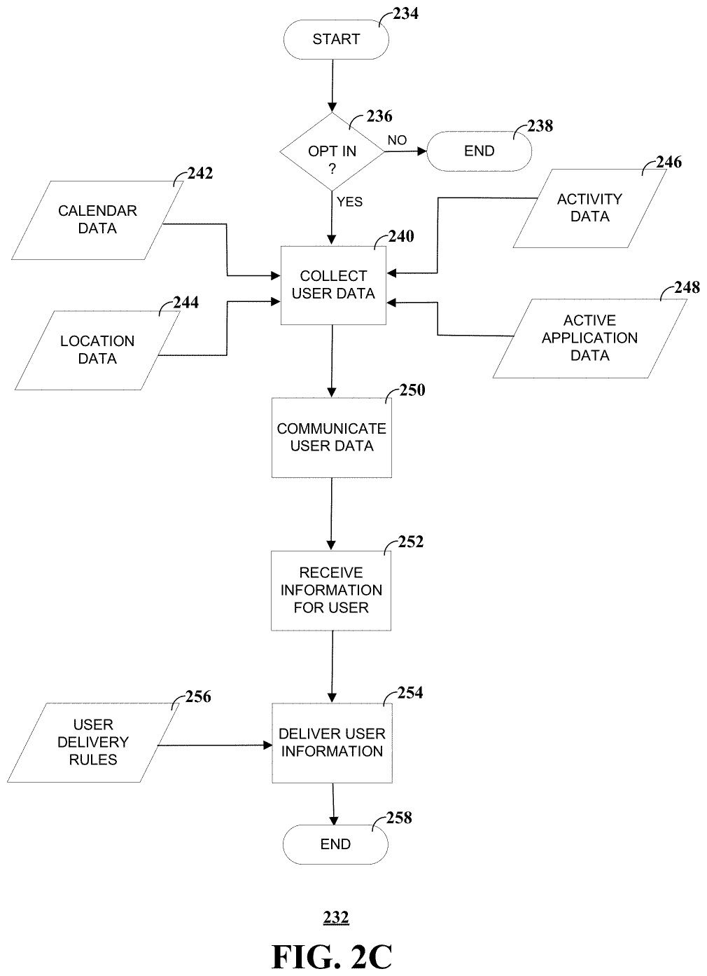

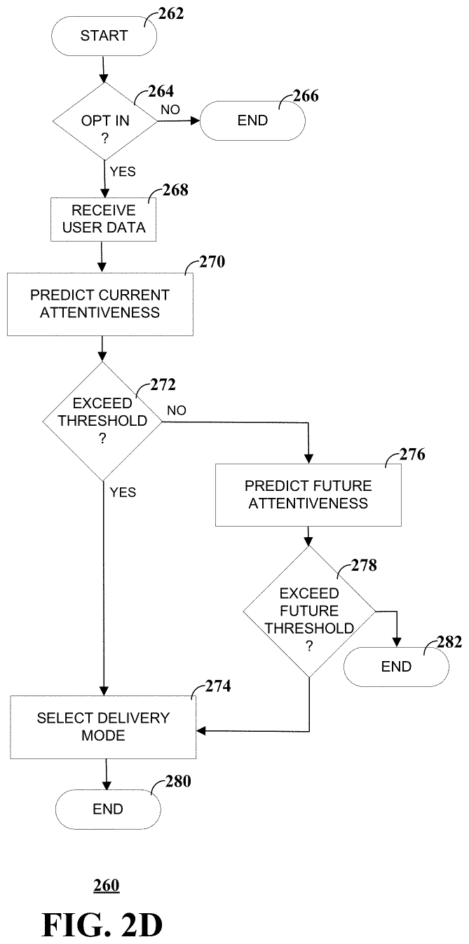

FIG. 2A is a block diagram illustrating a first exemplary, non-limiting embodiment of a system 200 for predicting ability of a user to interact with presented content such as advertising that may function within the communication network of FIG. 1 in accordance with various aspects described herein. The system 200 in one illustrated embodiment includes an attentiveness predictor 202, an attentiveness database 204, an advertisement engine 206, an advertisement database 208, one or more communication networks such as communication network 210, one or more users such as user or individual 212, and one or more client devices 220 associated with the individual such as a mobile device 214, a smart speaker 216 and a network appliance such as a smart television 218. In other embodiments, the system 200 may include other combinations of components and functionality. For example, server-side devices such as the attentiveness predictor 202 and the advertising engine 206 can be combined in a single device, multiple devices or can be provided via a distributed computing environment including in a virtual environment. While only a single user or individual 212 is shown in the exemplary embodiment of FIG. 2A, it is to be understood that the features described herein of the system 200 are to be offered to a wide variety of users including, in some examples, a group of users, such as a group of family members operating under a single subscriber agreement. The embodiment of system 200 of FIG. 2A is intended to be exemplary solely in order to illustrate pertinent principles of the subject disclosure.

The individual 212 has access to one or more client devices 220 which may be operable to provide content to the user or individual 212. Content includes one or more items of information. Such items of information are intended for consumption by the individual, including reading text, viewing images and video and hearing audio. Content may include the widest variety of information that may be useful or informative to the individual 212. Content may originate in one of the client devices 220 or content may be received over a network such as the network 210 from a remote source.

Content may include messages addressed to the individual, such as electronic mail (email) messages, short message service (SMS) messages or other messages communicated among the individual and one or more other users. Such messages may include text, images, video, audio and other information, which may be configured as a file attached a message. Such messages are usually self-contained and may invite a response. Such messages generally require a relatively limited ability of the individual 212 to interact with a message. For example, the individual 212 may read the text of a message, view an attachment, and prepare and send a response.

Content can include information that is streamed. Examples include video or audio content having a defined duration, such as a 15- or 30-second advertisement, a 90-minute video, a 3-minute song, a television program, movie or other scheduled programming or other item of information delivered to one or more client devices 220 of the individual 212. Other examples may include content that is streamed and that has an essentially unlimited duration, such as some social media feeds. The streamed content may include multiple discrete items, such as a video content item preceded by or interspersed with advertisements, or a social media feed that includes advertisements interspersed among other content items of interest. The content may be requested by the individual 212 or may be selected for provision to the individual 212 if it is determined to be of potential interest to the individual 212. Requested content may include, for example, a movie that is downloaded or streamed for viewing at the request of the individual 212. Selected content may include, for example, advertisements that relate to the substance of the movie or other content items in which the individual has shown a past interest.

The content may be delivered to one or more client devices 220 of the individual 212. The same or similar content items may be delivered to more than one of client devices 220 of the individual 212. For example, the individual 212 may be watching a program on smart television 218 while having mobile device 214 at hand and smart speaker 216 nearby. Moreover, the individual 212 may have other client devices 220 at hand, such as a laptop computer, a tablet computer and a wearable device such as a smart watch. All of these devices are examples of client devices 220 by which the individual 212 may consume content.

The ability of the individual 212 to interact with a received item of information may vary depending on time, location and other activities of the individual 212. Ability to interact may be defined variably depending on the nature of the item of information or content. For example, the individual 212 watching a movie or program on smart television 218 may have a substantial ability to interact with the content presented there, including advertisements presented with the movie, because the individual has set aside time to be in the location of the smart television 218 to watch the movie. As another example, when the individual 212 is commuting, the individual 212 will have a relatively low ability to interact with content when driving a car or walking on a busy street, but the individual 212 will have a relatively higher ability to interact with content when riding on a bus or train. When driving, the individual 212 may be completely unable to interact with content. When riding on a train, the individual 212 may be able to interact with some types of content such as messages or streaming content for a limited time. When located at work in an office environment, the individual may have a much greater relative ability to interact with items of information such as content.

The individual 212 may thus be considered to have a relative ability to interact with content. The relative ability to interact with content will vary with time, location, other activities of the individual 212, and other factors as well. The relative ability to interact with content may be referred to as a relative attentiveness level. The relative ability to interact with content includes ability to see or hear or otherwise acknowledge a received information item or content item presented to the individual by one or more client devices 220. The relative ability to interact with content may also include the ability to actively respond to an item of information, such as by viewing a file attached to a received message, or by preparing and sending an answer to the message, or by responding to an advertisement by viewing the advertisement, by clicking an embedded link or by calling a contact number, for example. The relative ability to interact with content is related to the nature of the content or other information item. The relative ability to interact with content is also a function of the current activity and location of the individual. It may also be a function of past activity and locations of the individual.

Client devices 220 may have access to user data associated with the individual 212. The user data may be entered by the individual 212, such as contact information reflecting colleagues, friends and family of the individual and calendar entries reflecting activities of the individual. The user data may be detected in information provided by or received by one of the client devices 220, such as information about content items viewed, location information originated by a location tracking function of one or more of the client devices 220, and activities of the individual 212.

In some examples, the user data may include location data indicating current or past geographic locations of the individual 212 or a device associated with the individual 212. For example, the mobile device 214 may include a location detecting function such as a Global Positioning System (GPS) receiver that determines and reports current location information of the mobile device 214. Even if a client device of the client devices 220 is not mobile in nature, it may provide location data for the individual 212. For example, if the individual 212 provides an oral command to the smart speaker 216 or selects a program for viewing on the smart television 218, those client devices may provide location data indicating that, at the time of the oral command or program selection the individual 212 was at the location of the smart speaker 216 or the smart television 218. Location data for the individual may have a temporal component defining when the individual was at the physical location. Location data will typically represent past or current locations but may include predicted or scheduled future locations as well, particularly if the location data is combined or informed by other user data of the individual such as calendar data.

In other examples, the user data may include calendar data. Calendar data may include appointments and scheduled events. In one example, the mobile device 214 includes a calendar application used by the individual to store and track information about appointments and scheduled events. The calendar application may be synchronized or provide information to and receive information from other devices and activities of the individual. In one example, the mobile device 214 has an application (“app”) that synchronizes over a network such as the Internet or other network 210 with a global calendar application associated with the individual 212. Similarly, the smart speaker 216 may synchronize with the global application and may respond to spoken inquiries of the individual 212 such as “tell me my appointments tomorrow.” Calendar data may include past, current and future data as well as location information if an appointment is recorded in a calendar with a location for the appointment.

In other examples, the user data may include sensor data associated with a current or past environment of the individual. The client devices 220 may include one or more sensors. For example, the client devices 220 may include a smart thermostat located in the environment of the individual 212. The smart thermostat may report, over time, a current ambient temperature and a current temperature set point of the smart thermostat. In another example, a client device of the client devices 220 may include an ambient noise sensor that reports an ambient noise level. The reported ambient noise level may be qualitative in nature, such as “quiet” or “noisy,” or may be quantitative in nature, such as a noise level in decibels. In another example, a client device of the client devices 220 may include a sensor which detects presence of other persons in the environment of the individual 212. For example, a set top box or other media processor may detect presence of more than just the individual watching a content item on the smart television 218.

In other examples, the user data may include activity data for the individual 212. Such activity data may reflect past or current physical activity of the individual 212. For example, a wearable device of the client devices 220 that may detect that the individual 212 is currently running for exercise or working out at a gym. An in-car monitor of the client devices may detect that the individual 212 is driving, including reporting the route taken by the individual 212 and a destination entered into a mapping function of the in-car monitor. Such activity data may reflect commercial or other activity of the individual 212. For example, if the mobile device 214 is used to make a purchase, data about the purchase may be reported by the mobile device 214 as user data.

In other examples, the user data may include active application data reflecting current or past activities of the individual 212 using an application program (“app”) on one of the client devices 220. At least some of the exemplary client devices 220 are equipped with applications providing functionality to supplement the basic functionality of the client devices 220. For example, the mobile device 214 and the smart television 218 have web browser applications providing access to web pages over the Internet. These devices may both provide access to social media applications such as Facebook® and Twitter®. If the individual 212 is engaged with such an application, that engagement may be reported as user data of the individual.

In some exemplary embodiments, user data may also be stored on client devices 220 including mobile device 214 associated with the individual 212. This data may include types of information that may be used to predict how attentive the party may be at any given time to receiving content including an advertisement that may be presented to the individual. The predicted attentiveness may include the relative ability of the individual 212 to interact with content items including the advertisement.

Moreover, one or more client devices 220 may include a virtual assistant 222. A party such as individual 212 may have access to the virtual assistant 222 as an app on the mobile device 214, as a standalone virtual assistant device, or via a non-mobile device that has network connectivity, such as smart television 218 or a networked household appliance such as smart speaker 216. The virtual assistant 222 operates to manage information flowing to and from the individual 212. The virtual assistant 222 has access to user data including location data, calendar data, activity data and active applications data. The virtual assistant 222 may control presentation of information items to individual based on factors such as location and activity, and according to rules established by the individual 212.

In exemplary embodiments, the client devices 220 and the virtual assistant 222 may communicate with the advertisement engine 206 and the attentiveness predictor 202 to use the user data about the individual 212 to predict the individual's current level of ability to interact with content, how long that level of ability may exist, a future level of ability to interact with content, and a best mode for delivering content including an advertisement to the individual 212.

The attentiveness predictor 202 is operative to receive from the client devices 220, the virtual assistant 222, or both, user data about the individual 212. The client devices 220 or the virtual assistant 222 may be configured to send the user data over network 210 to the attentiveness predictor 202. For example, the client devices 220 may each implement a client side application which operates in conjunction with a server side app at the attentiveness predictor 202 to automatically report the user data of the individual. For preservation of privacy of the individual 212, the individual may first be required to actively agree to sharing of some or all of his user data in an opt-in process. If the individual does not opt-in to data sharing, the attentiveness predictor 202 may not receive the user data.

The client devices 220 or the virtual assistant 222 may send any suitable user data to the attentiveness predictor 202. The attentiveness predictor 202 may in turn make conclusions based on the user data about the ability of the individual 212 to interact with content if the content or item of information is sent to the individual 212. Examples of such user data include calendar data, location data, activity data and active application data of the individual 212. A further example of such user data is a user-managed availability parameter that the user may set to specify the user's mood or availability. The user data may originate with any of the client devices 220 and may include the widest variety of information about the individual 212.

In one example, calendar data of the individual may indicate that the individual is currently in a meeting or at a child's piano recital. Such user data may be interpreted by the attentiveness predictor 202 to indicate a relatively low likely attentiveness level for the individual 212, meaning that the individual's ability to engage with content of any sort at the current time is relatively low. Any content item sent to the individual now will likely be ignored by the individual 212 until a later time. This is a poor time to send an advertisement to the individual 212.

In another example, current location data for the individual may indicate that the individual is at a laundromat or traveling on a plane. Such user data may be interpreted by the attentiveness predictor 202 to indicate a relatively high attentiveness level for the individual 212 at the current time. To the attentiveness predictor 202, this may mean that the individual's ability to engage with content at the current time is relatively high. Any content item sent to the individual now will likely viewed on a client device such as mobile device 214. If the content item requires interaction, such as selecting an attachment to view, or actively responding by clicking an embedded link or sending a responsive message, the interaction will likely occur. In the example circumstance, the individual 212 is apparently not otherwise engaged by more pressing activities and has a high likelihood of engagement with the content. This is a good time to send and advertisement to the individual. The advertisement will be likely well-received by the individual.

In another example, activity data for the individual 212 may indicate that the individual is currently exercising. Such user data may be interpreted by the attentiveness predictor 202 to indicate a likely low attentiveness level. To the attentiveness predictor 202, this may mean that the individual's ability to engage with content at the current time is relatively low, as the individual is otherwise engaged and not disposed to receipt of content including advertisements.

In some embodiments, the attentiveness predictor 202 may cooperate with attentiveness database 204 to store and retrieve historical user data for users such as the individual 212. The historical data may include past data of any nature received from client devices 220 or virtual assistant 222 for the individual 212. The historical data may include past calendar data representing past appointments and activities of the individual 212. The historical data may include past location data representing past locations accessed by the individual 212. Similarly, the historical data may include past activity data about past activities of the individual and past active application data showing past engagement with applications on one or more devices. In some embodiments, in place of or in addition to storing past user data as historical data at the attentiveness database 204, the attentiveness predictor 202 may receive or request past data from client devices 220. User privacy protection may require the individual 212 to actively select communication or use of such historical data.

The historical data retrieved from the attentiveness database 204 may be used in conjunction with current user data by the attentiveness predictor 202. For example, the received activity data for the individual 212 may indicate that the individual is currently exercising and received location data may indicate that the individual is currently hiking in a local park. This current activity may indicate to the attentiveness predictor 202 a likely low attentiveness level of the individual 212. However, upon retrieving historical data from the attentiveness database 204, the attentiveness predictor 202 may discern that in the past, when the individual 212 has been hiking in the park, the individual has received text messages and responded to senders with additional text messages. This current activity combined with historical data may indicate to the attentiveness predictor 202 a likely medium or high attentiveness level of the individual 212. In yet another example, the retrieved historical data may indicate that in the past, the individual 212 received an advertisement as part of a message and clicked on a link in the advertisement. These past activities may be perceived by the attentiveness predictor 202 as indicating a high attentiveness level of the individual 212 at the current time.

In another example, active application data received by the attentiveness predictor 202 may be interpreted by the attentiveness predictor 202 to indicate that the user has been scrolling through social media for the past 15 minutes. This, in turn, may be interpreted by the attentiveness predictor 202 to indicate a potential high attentiveness level for the individual 212. In another example, the active application data may indicate the individual 212 is on a telephone call or using a collaboration app on one of the client devices 220. Both of these examples of user data, in turn, may be interpreted by the attentiveness predictor 202 to indicate a potential low attentiveness level for the individual 212.

The user-managed availability parameter may be used by the user to signal current or future availability or mood of the user. The availability parameter may have multiple optional values that may be set by the user to indicate willingness to interact with others, currently or in the future. Metaphorically, the availability parameter operates like an individual's office door with blinds to indicate a willingness to be interrupted, where the user can leave the door wide open, slightly ajar, closed with the blinds open, or closed with the blinds closed to indicate user mood or availability. Setting the availability parameter to a first value corresponds to door wide open and available; setting the availability parameter to a second value corresponds to door slightly ajar and limited availability; setting the availability parameter to a third value corresponds blinds open and more-limited availability; setting the parameter to a fourth value corresponds to door closed or blinds closed to indicate unavailable, do not disturb. Any suitable number of gradations of availability may be specified and communicated to others such as over one or more networks. The attentiveness predictor 202 may receive the availability parameter and respond with suitable conclusions about the user's attentiveness level.

The user data, including current user data received from the client devices 220 or the virtual assistant 222 and historical data retrieved from the attentiveness database 204, may form predictors about current or future behavior of the individual. In particular, the predictors may provide an indication of the relative ability of the individual 212 to interact with content including advertisements, now or in the future. Such predictors may be used individually or may be combined using a weighted average or other equation to determine a predicted attentiveness score.

Various weighting techniques may be employed by the attentiveness predictor 202. Current user data and historical user data may be weighted differently. For example, current user data received from the client devices 220 or the virtual assistant 222 may be given a first weighting value, such as 0.8, and historical user data from the attentiveness database 204 may be given a second weighting value, such as 0.2. The current user data is weighted more heavily that historical data in this example.

In another example, user data may be weighted based on a client device from which it is received. For example, user data received from a wearable device such as a smart watch or a mobile device may be weighted at a relatively high value, such as 0.9, and interpreted by the attentiveness predictor 202 as being highly predictive of the current ability of the individual 212 to engage and interact with content such as an advertisement. In contrast, user data from the smart speaker 216 or the smart television may be weighted at a relatively low value, such as 0.1, and interpreted by the attentiveness predictor 202 as being only slightly predictive of the current ability of the individual 212 to interact with content.

The attentiveness predictor 202 may develop any suitable mathematical relationship relating the current user data and historical data from various sources to determine a predicted attentiveness score. The predicted attentiveness score may be a scalar or vector value, including a multi-dimensional vector value, indicating the likelihood or ability of the individual 212 to interact with content provided to the individual. For example, the various dimensions of analysis implemented by the attentiveness predictor 202 may include current user data versus historical data, data from a mobile device such as mobile device 214 and wearable devices versus data from static devices such as smart speaker 216 and smart television 218, etc. Any other suitable combinations of data may be used or selected. Moreover, the attentiveness predictor 202 may implement a machine learning algorithm to learn patterns of activity of the individual and discern the likelihood of the individual to interact with content items including advertisements. Historical user data retrieved from the attentiveness database 204 may form training data for the machine learning algorithm.

The attentiveness predictor 202 and the attentiveness database 204 may be in data communication with the advertisement engine 206 and the advertisement database 208, for example, over the network 210. The network 210 may include any suitable data communication network such as the Internet and any associated internal networks. The attentiveness predictor 202 and the advertisement engine 206 may be implemented an any suitable data processing system such as a server having network communication capabilities. The attentiveness database 204 and the advertisement database 208 may be implemented by any suitable data storage system such as a disk drive or active memory.

The attentiveness predictor 202 in various embodiments determines a relative ability to interact with content such as advertisements by the individual 212. As noted, in some embodiments, this may include determining a predicted attentiveness score. Based on the predicted attentiveness score, the attentiveness predictor 202 may communicate with the advertisement engine 206 to indicate whether or not to deliver an advertisement to the individual 212. In some embodiments, the indication from the attentiveness predictor 202 to the advertisement engine 206 is simply an instruction to deliver an advertisement. The advertisement engine 206 selects a suitable advertisement, for example based on demographics of the individual, location of the individual, behavior of the individual and other factors. In this regard, at least some user data for the individual may be shared with the advertisement engine 206.

In other embodiments, the relative value of the predicted attentiveness score may be used to determine the mode by which to deliver the ad. A selected mode may refer to the nature of the advertisement, such as a low-engagement display ad sent with an email message or a high-engagement video ad sent as part of a web page to a browser or before a movie downloaded or streamed to the smart television. A selected mode may refer to the client device for delivery of the advertisement, such as a web browser of the mobile device 214 versus a web browser of the smart television 218. For example, a relatively high predicted attentiveness score may indicate to the attentiveness predictor 202 that a video ad may be delivered to the individual. The attentiveness predictor 202 will communicate suitable information to the advertisement engine 206. A relatively low predicted attentiveness score may indicate to the attentiveness predictor 202 that an email ad may be delivered. The attentiveness predictor 202 will communicate suitable information to the advertisement engine 206. The advertisement engine will request an appropriate advertisement from the advertisement database 208 and deliver the advertisement for presentation to the individual 212. The advertisement engine 206 may select the advertisement based on factors such as location and demographics of the individual.

The advertisement engine 206 delivers the selected advertisement according to the determination of the attentiveness predictor 202. For example, if the attentiveness predictor 202 determined that the advertisement should be delivered in an email message to the mobile device 214 of the individual 212, the advertisement engine 206 incorporates the advertisement into an email message. In some cases, if the attentiveness predictor 202 determines that the advertisement should be included at a specified time point of a streaming video presentation at the smart television 218 of the individual 212, the advertisement engine 206 incorporates the advertisement accordingly. The advertisement engine 206 may cooperate with other network devices (not shown in FIG. 2A) to combine the selected advertisement with other content items.

In some embodiments, the selected advertisement may be delivered via the virtual assistant 222, which may act as a gatekeeper for the individual. The virtual assistant 222, for example, may implement one or more user delivery rules that control delivery of advertisements to client devices 220 associated with the individual. The user delivery rules may limit the time or duration of advertisements that may be delivered, or the type or mode of advertisement delivery. For example, the individual 212 may speak to the virtual assistant 222 a command such as “hold all communications” or “no ads today” which may override or postpone delivery of the ad. Other examples may be readily imagined.

In some embodiments, the attentiveness predictor 202 may determine not only a predicted attentiveness level for the individual 212, but also how long that level may exist, or a predicted duration of the attentiveness level. The predicted duration may be based on any suitable information, including the user data received by the attentiveness predictor 202 from the client devices 220 and the virtual assistant 222. This includes calendar data for the individual 212, location data, activity data, active application data and any other information available. This may also include historical user data retrieved by the attentiveness predictor 202 from the attentiveness database 204.

For example, the attentiveness predictor 202 may use calendar data to determine that not only is the individual 212 currently in a meeting, but the individual 212 is expected to be there for the next 3 hours. This may be interpreted by the attentiveness predictor 202 to indicate a relatively low predicted attentiveness. After that, the calendar data of the individual 212 indicates that the calendar is clear of other appointments and, based on their past trends indicated by the historical data retrieved from the attentiveness database 204, the individual 212 is likely to be getting on a train to go home after the meeting. This corresponds, for the attentiveness predictor 202, to a relatively higher predicted attentiveness level. Thus, the predicted duration of the relatively low attentiveness level is three hours, when the individual is in the meeting, and when the individual 212 has a relatively low ability to interact with content such as an advertisement that may be sent.

In another example, the attentiveness predictor 202 may determine that the individual 212 has just used a ride-sharing app of the mobile device 214 to hail a ride and will be on the ride for the next 45 minutes. This information may be received as active application data from the mobile device 214, combined with location data from the mobile device 214. This information may be used to predict a relatively high attentiveness level for the individual 212 as well as a predicted duration of the attentiveness level of 45 minutes. This information may be used to queue up a sequence of ads for delivery with the expectation that the individual will have a relatively high ability to interact with the advertisements.

In some embodiments, the attentiveness predictor 202 may also use the user data of the individual 212 to predict a best mode for delivery of an advertisement when the individual 212 is determined to be at a sufficient level of attentiveness or to have a sufficiently high level of ability to interact with content such as an advertisement. For instance, if the attentiveness predictor 202 determines the individual 212 is traveling on a train and is determined via their active application data to be using Bluetooth headphones, the attentiveness predictor may conclude that an audio advertisement may be best suited for the situation. The same may be true if the attentiveness predictor 202 determines that the individual is listening to audio programming through a Bluetooth connection to a car audio system. The attentiveness predictor 202 may communicate suitable information to the advertisement engine 206 and the advertisement engine 206 may select a suitable advertisement accordingly from the advertising database 208 and send the advertisement, for example to the individual 212 via the virtual assistant 222.

In another example, if the individual 212 is currently scrolling through a social media feed such as that provided by the Facebook app, the advertisement engine 206 may select an ad that is appropriate for the user based on demographics and other information and is formatted for Facebook. The advertisement engine 206 may send the selected advertisement to the Facebook app of the mobile device 214 associated with the individual 212. The app will enable real-time insertion of the selected advertisement into the next available ad slot in the stream presented to the individual 212 by the Facebook app. The event of the insertion of the ad may be transparent to the individual 212. However, the advertisement has been selected for the individual 212 based on information known about the individual 212 such as demographics, location, behavior and other information. Also, the advertisement has been selected and provided based on the prediction of the ability of the individual 212 to interact with the advertisement. As a result, exemplary system 200 provides a substantial benefit to the advertiser associated with the advertisement by making their ad most likely to be consumed. The exemplary system 200 also provides a benefit to the individual 212 by making the presentation at a most convenient time and means for the individual 212.

FIG. 2B depicts a second exemplary, non-limiting embodiment of a system 225 for predicting ability of a user to interact with presented content such as advertising and functioning within the communication network of FIG. 1 in accordance with various aspects described herein. The system 225 of FIG. 2B includes server-side devices including an alerting engine 224, a messaging server 226, an information feed server 228 and a social media feed server 230. Other embodiments of the system 225 may include other components and systems as well as, or instead of, those illustrated in FIG. 2B. In some embodiments, the server-side devices can be combined in a single device, multiple device or provided via a distributed computing environment including in a virtual environment. The embodiment of FIG. 2B is intended to be exemplary only.

It should be noted that the apparatus and method illustrated in conjunction with FIG. 2A for predicting an attentiveness level and sending an advertisement to an individual 212 may also be extended to other types of communications to be sent to the individual 212. The embodiment of FIG. 2B enables such extension. These other communications may include messages such as emails or text messages provided by the messaging server 226. These other communications may further include information feeds, such as news alerts, provided by the information feed server 228. These other communications may further include social Media Feeds, such as direct messages or postings provided by social media feed server 230. These communications may include other types of communications that may be presented as text, audio, video, virtual reality, augmented reality, hologram, or other types of media.

In accordance with some embodiments, then, the attentiveness predictor 202 may determine for the individual 212 a relative ability to interact with content, similar to the functionality described herein in connection with the attentiveness predictor 202 illustrated in FIG. 2A. In the system 225 of FIG. 2B, the attentiveness predictor 202 determines for the individual a relative ability to interact with content such as emails or text messages, information feeds and social media feeds. In some embodiments, the relative ability to interact, which may be referred as a relative attentiveness level, may be determined as a relative attentiveness score. If the relative attentiveness score exceeds a predetermined engagement threshold, the attentiveness predictor 202 may conclude that one or more of a message, an information feed, or a social media feed may be sent to the individual. If the relative attentiveness score does not exceed the predetermined engagement threshold, the attentiveness predictor 202 may suppress communications to the individual 212 such as messages from the messaging server 226, information feeds from the information feed server 228 and social media feeds from the social media feed server 230.

The attentiveness predictor 202 may determine the relative ability to interact with content for the individual 212 based on current user data received from the client devices 220 or based on historical data received from the client devices 220 or retrieved from the attentiveness database 204, or both. The relative ability to interact with content may be based on calendar data, location data, activity data, active application data or any other information available to the attentiveness predictor 202. Moreover, the user data may be used individually or may be combined using a weighted average or other equation to determine the predicted attentiveness score or relative ability to interact with content.

Based on the predicted attentiveness score, the attentiveness predictor 202 may communicate with the messaging server 226 to indicate whether or not to deliver a message to the individual 212. Similarly, based on the predicted attentiveness score, the attentiveness predictor 202 may communicate with the information feed server 228 to indicate whether or not to deliver an information feed to the individual 212. Similarly, based on the predicted attentiveness score, the attentiveness predictor 202 may communicate with the social media feed server 230 to indicate whether or not to deliver a social media feed to the individual 212.

The relative value of the score may be used to determine the mode by which to deliver the message, information feed or social media feed. For example, a relatively higher score may indicate that an information feed including video data may be delivered to the individual 212. A relatively low score may indicate that an email message may be delivered by the messaging server 226 to the individual 212. The appropriate message or feed is requested from the appropriate server and is delivered for presentation to the individual 212.

The individual 212 may use the virtual assistant 222 as a gatekeeper again in the system 225 of FIG. 2B. For example, the individual 212 may submit a command such as “Turn off my social media for the next 24 hours” or “Send me news alerts about the hurricane forecast even when I′m not attentive.”

FIG. 2C is a flow diagram illustrating an exemplary, non-limiting embodiment of a method 232 of operation of a client device in the system 200 of FIG. 2A or the system 225 FIG. 2B in accordance with various aspects described herein. The method 232 begins at block 234. The method 232 may be implemented, for example, on the mobile device 214, the smart speaker 216, the smart television 218 or other client devices 220 associated with the individual 212. For example, the method may be embodied as an application (“app”) running on the client device and in conjunction with a server-side app on, for example, a server implementing the attentiveness predictor 202. In particular embodiments, a client device is implemented on a data processing system including a processor and memory such as a database. The memory may store instructions for performing operations by the processing system. The operations may include, among others, operations to perform the steps of method 232.

At block 236, the client device determines if the individual 212 has opted-in to an attentiveness estimation service and associated functionality. To give a user the opportunity to manage privacy of user data, the user is preferably given the option to not participate in the attentiveness estimation process. If the user does not approve, the method 232 ends at block 238. No further action to monitor or collect user data for estimating the user's ability to interact with content will be taken.

If the user does approve participation, at block 240, the client device begins collecting user data. A client device may have access to a variety of user data associated with a user. The user data may be manually entered by the user, such as contact information reflecting colleagues, friends and family of the individual or calendar entries reflecting activities of the user. The user data may be detected in information provided by or received by the client devices, such as information about content items viewed, location information originated by a location tracking function of the client device, and activities of the user.

In one example, collecting user data, block 240, may include collecting calendar data 242. Calendar data 242 may include appointments and scheduled events of the user. In one example, the client device includes a calendar application used by the user to store and track calendar data 242 about appointments and scheduled events of the user. Calendar data 242 may include past, current and future data as well as location information if an appointment is recorded in a calendar with a location for the appointment.

In some examples, the user data may include location data 244 indicating current or past geographic locations of the user or client device. For example, the client device may include a location detecting function such as a Global Positioning System (GPS) receiver that determines and reports current location data 244 of the client device. Location data 244 for the user may have a temporal component defining when the user was at the physical location. Location data 244 will typically represent past or current locations but may include predicted or scheduled future locations as well.

In other examples, the user data may include activity data 246 for the user. Such activity data 246 may reflect past or current physical activity of the user. Activity data may originate, for example, from a wearable device that may detect physical activity of the user. Such activity data 246 may reflect commercial or other activity of the individual 212 such as a record of a purchase made by the user.

In other examples, the user data may include active application data 248 reflecting current or past activities of the individual 212 using an app on the client device. Such apps provide functionality to supplement the basic functionality of the client device. Examples of applications include web browsers, email applications and social media applications. If the client device operates an application, application data 248 may be collected at block 240 as user data of the individual.

User data may originate from other sources, as well, and reflect past, current and future activities of the user. Such user data may provide the ability to estimate the user's ability to interact with content if the content is provided to the user. The content to be provided may include an advertisement, a message, an information feed or a social media feed.

At block 250, the user data is communicated by the user device to a remote device for estimation of the user's relative ability to interact with content. This may also be referred to as the user's predicted relative attentiveness. In some embodiments, this estimation may be done at the client device. In the embodiment of FIG. 2C, the user data from the client device and from other sources, such as other client devices, is communicated, block 250, to a remote location for estimation of the user's relative ability to interact with information items such as content. For example, an attentiveness estimator function may be established on a remote server that is configured to receive the user data and determine the estimated user ability to interact with content. In some embodiments, the remote server may implement a server-side app that cooperates with a client side app implemented on the client device. The server may be associated with a memory such as a database that collects and stores user data including the calendar data 242, the location data 244, the activity data 246 and the active application data 248 from the client device. The collected and stored data may be used by the server and the attentiveness estimator function to determine the user's predicted relative attentiveness.

After the user data is communicated to the attentiveness predictor function, the attentiveness predictor function may make conclusions based on the user data about the ability of the user to interact with content if a content or item of information is sent to the user. The attentiveness predictor may use or develop any suitable mathematical relationship relating the current user data and any other data from various sources to determine a predicted attentiveness score. The predicted attentiveness score may be a scalar or vector value, including a multi-dimensional vector value, indicating the likelihood or ability of the user to interact with content provided to the individual.

Based on the predicted attentiveness score, the attentiveness predictor may communicate with an advertisement engine or other source to deliver an advertisement to the user. The advertisement engine selects a suitable advertisement, for example based on demographics of the individual, location of the individual, behavior of the individual and other factors. In this regard, at least some user data for the individual may be shared with the advertisement engine for selecting an advertisement to send to the user. In other embodiments, instead of or in place of an advertisement, a message or information feed or social media feed may be sent to the user, in accordance with embodiments shown in conjunction with FIG. 2B.

User information intended for the user is received at the client device at block 254. As indicated above, the user information may include an advertisement to display to the user, a message to display to the user, an information feed to display to the user or a social media feed to display to the user on the client device. Other user information may be delivered to the client device or instead.

Further, the client device may receive or retrieve one or more delivery rules, block 256, to control or override display of the user information received at block 254. For example, the delivery rules may defer display of the user information until a later time or inhibit display of the user information. For example, the user may have set a rule to “hold all communications” or “no ads today.” The delivery rules may be used to queue up a sequence of advertisements for delivery according to a schedule of availability set by the user. The delivery rules may be stored at the client device or retrieved from a remote location or be entered by the user.

Following delivery of the user information, possibly according to the user rules, the method ends at block 258.

FIG. 2D is a flow diagram illustrating an exemplary, non-limiting embodiment of a method 260 of operation of a network device in the system 200 of FIG. 2A or the system 225 FIG. 2B in accordance with various aspects described herein. The method 232 begins at block 234. The method 260 may be implemented, for example, in the attentiveness predictor 202 which communicates with one or more client devices 220. In particular embodiments, the attentiveness predictor 202 is implemented on a server computer. Operations of the attentiveness predictor method 260 may be implemented by the server or by any other data processing system including a processor and memory such as a database. The memory may store instructions for performing operations. The operations may include, among others, operations to perform the steps of method 260. The method begins at block 262.

At block 264, the method 260 may confirm that a user associated with a client device has opted-in to the service to estimate the user's ability to interact with content such as advertisements, messages, information feeds and social media feeds. In some embodiments, the user may opt in to the service for some but not all of these content types, or other content types. Confirming that the user has selected to participate ensures that user maintains desired control over user data. If the user does not opt in, the method ends at block 266 and no further actions are taken.

If the user does opt-in to the service, at block 268 user data is received by the attentiveness predictor method 260. The user data may include location data, calendar data, activity data, active application data or any other suitable data from the user or about the user. In one embodiment, the user data may be received over a network such as the Internet from one or more user devices associated with the user.

At block 270, the attentiveness predictor method 260 predicts a current attentiveness level for the user. The attentiveness level may correspond to the ability of the user to interact with content to be provided to the client device for consumption by the user. The attentiveness level or ability to interact with content may be a relative value. That is, at some times, the user may be more able to interact with content, for example, by viewing an advertisement or by reading a message. At other times, the user may be busy or otherwise engaged and therefore be less able to interact with content, such as when driving a car.

In some embodiments, the attentiveness predictor method 260 at block 270 may determine or predict an attentiveness score. The attentiveness score may be determined according to any suitable relation or equation. In some embodiments, the attentiveness score may be a scalar or vector value, including a multi-dimensional vector value, indicating the likelihood or ability of the user to interact with content provided to the user. For example, the various dimensions of analysis implemented by the attentiveness predictor method 260 may include current user data versus historical data, data from a mobile device or wearable devices versus data from static devices of the user, etc. Any other suitable combinations of data may be used or selected. Further, predicting current attentiveness may include determining a duration of the current attentiveness level. For example, if the user is on a journey that, based on time of day and location information corresponds to the user's commute to work, the attentiveness predictor method 260 may conclude that the current attentiveness level will last during the duration of the commute.

At block 272, the method 260 includes determining if the predicted attentiveness score exceeds a predetermined threshold. This may be done, for example, by comparing the attentiveness score with a predetermined interaction threshold. The threshold may be any suitable value or relationship or information against which the attentiveness score may be compared. In some embodiments, the threshold may be a set of thresholds for respective data types including location data, calendar data, activity data and active application data, or some combination of these.

If, at block 272, the attentiveness score exceeds the threshold, at 274, the method 260 include selecting a delivery mode for a content item. The mode may refer to the nature of an advertisement, such as a low-engagement display ad sent with an email message or a high-engagement video ad sent as part of a web page to a browser or before a movie downloaded or streamed to a smart television. The mode may refer to a particular client device for delivery of an advertisement or other content, such as a web browser of a mobile device or a web browser of a smart television.

If, at block 272, the attentiveness score did not exceed the threshold, at block 276, the method 260 predicts a further attentiveness. The future attentiveness may be based on prospective information such as calendar data for the user or based on historical information collected for the user demonstrating a pattern or behavior under particular circumstances. Future attentiveness may be predicted in any suitable manner, such as by computing a future attentiveness score.

At block 278, the method determines if future attentiveness exceeds a future threshold, control proceeds to block 274 to determine a delivery mode for a content item. If the future attentiveness does not exceed the future threshold, the method ends at block 282. After selection of the delivery mode, block 274, the method ends at block 280. [00095]

While for purposes of simplicity of explanation, the respective processes are shown and described as a series of blocks in FIGS. 2C and 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

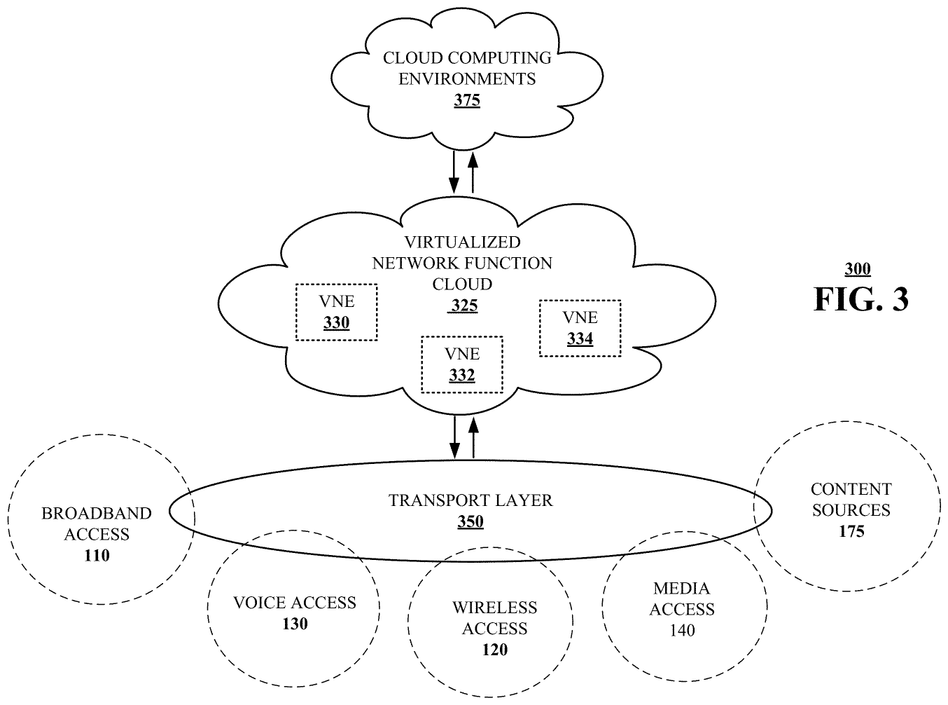

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of systems 200 and 225 and method 232 and 260 presented in FIGS. 1, 2A, 2B, 2C, 2D. For example, virtualized communication network 300 can facilitate in whole or in part communicating user data about location and activities of a user and determining a prediction of attentiveness of the user, or the ability of the user to interact with content presently or in the future.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third party locations.

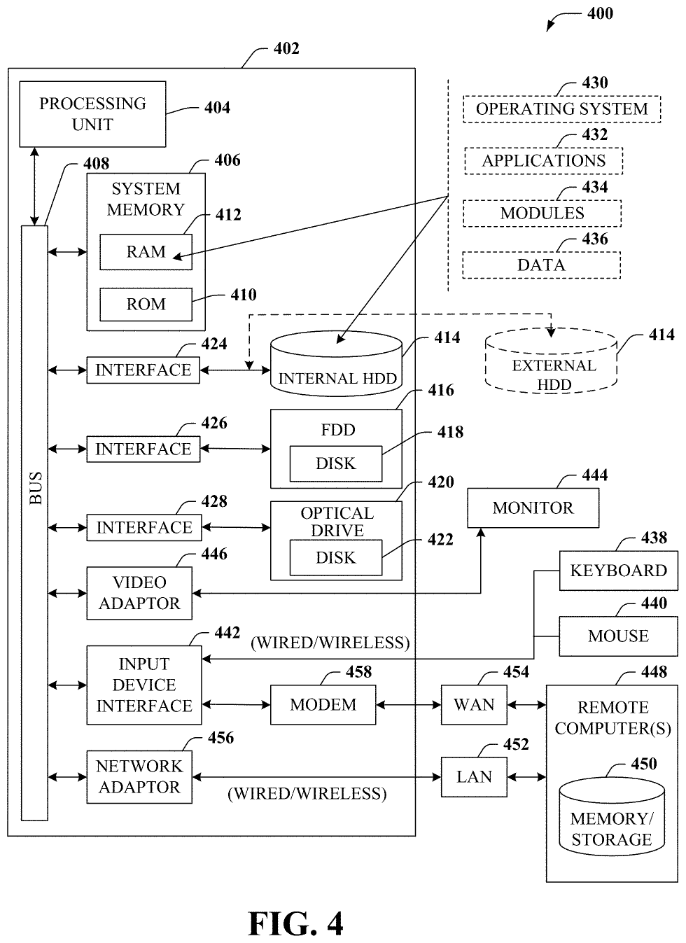

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Further, the computing environment 400 can be used in the implementation of client devices 220, attentiveness predictor 202 or advertisement engine 206 of FIG. 2A and FIG. 2B. Each of these devices can be implemented via computer-executable instructions that can run on one or more computers, and/or in combination with other program modules and/or as a combination of hardware and software. For example, computing environment 400 can facilitate in whole or in part a process of communicating user data about location and activities of a user and determining a prediction of attentiveness of the user, or the ability of the user to interact with content presently or in the future.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in some embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

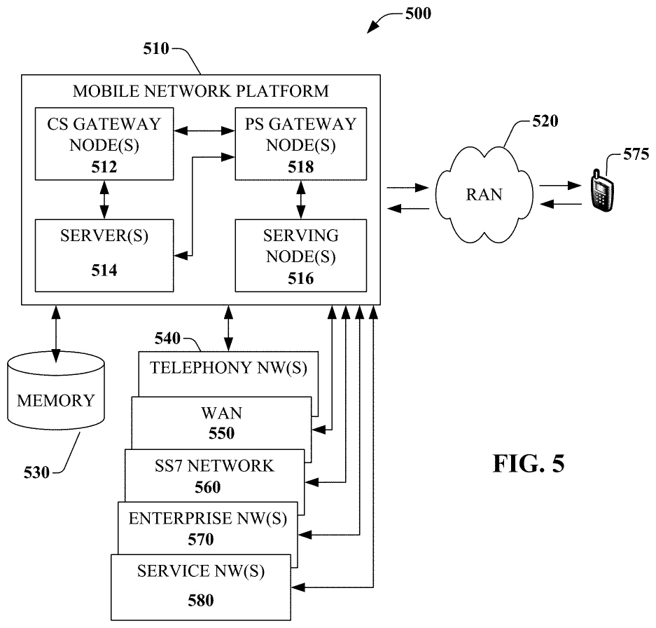

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part communicating user data about location and activities of a user and determining a prediction of attentiveness of the user, or the ability of the user to interact with content presently or in the future. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

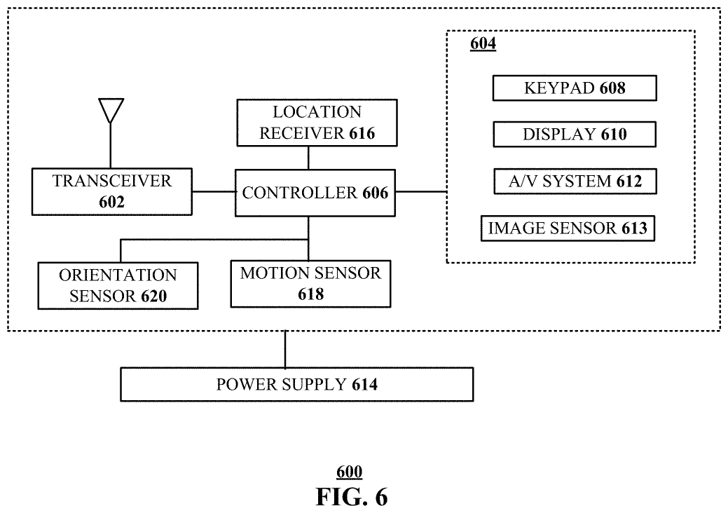

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part communicating user data about location and activities of a user and determining a prediction of attentiveness of the user, or the ability of the user to interact with content presently or in the future. The communication device 600 may implement, for example, a client device such as the client devices 220 of FIG. 2A and FIG. 2B.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. In other examples, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. In addition to or in place of GPS signals, modern devices also look for WiFi signals, Bluetooth signals, including both standard and low-energy versions, and other localized radio beacons to replace or supplement GPS location information. GPS does not provide useful location information inside buildings, especially multi-story buildings, so these other signals often provide more precise information using information such as databases of stored locations. In addition, new fifth generation (5G) mobile radio systems operating at the higher frequencies designated for 5G networks will also be able to provide more precise supplementary location information. In exemplary embodiments—the location receiving 616 may employ such noted location technology alone or in combinations. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) or machine learning (ML), or a combination of the two, to facilitate automating one or more features described herein. The embodiments (e.g., in connection with automatically identifying acquired cell sites that provide a maximum value/benefit after addition to an existing communication network) can employ various AI-based or ML-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments. [000147] Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” “subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” “data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A device, comprising:
a processing system including a processor; and
a memory that stores executable instructions that, when executed by the processing system, facilitate performance of operations, the operations comprising:
receiving, from a client device, over a network, information about activities of an individual associated with the client device;
predicting, for the individual associated with the client device, an ability to interact with content, the ability to interact with content indicating an ability of the individual for receiving additional information that may be presented to the individual;
comparing the ability to interact with content with a predetermined interaction threshold;
based on the comparing, selecting one or more items of information to present to the individual;
based on the ability to interact with content, selecting a mode for providing the one or more items of information to the individual, wherein the mode is selected from one of a text message, an electronic mail message, video content, audio content, a display advertisement and a video advertisement;
receiving, from the client device according to user input at the client device by the individual, one or more delivery rules to override presentation of information including the one or more items of information at the client device and to specify a mode for providing the one or more items of information;
responsive to the one or more delivery rules, deferring presentation of information including the one or more items of information to the client device;
responsive to the one or more delivery rules, forming a schedule for subsequent delivery of information to the client device following the deferring presentation according to the one or more delivery rules;
responsive to the one or more delivery rules, selecting a different mode for providing the one or more items of information to the individual; and
communicating the one or more items of information to the client device according to the schedule and the different mode.

2. The device of claim 1, wherein the operations further comprise:
based on a value of the ability to interact with content and the information about activities of the individual, selecting a delivery mode for delivery to the client device for presenting the one or more items of information to the individual, wherein the delivery mode is selected based on the client device for delivery of the one or more items of information.

3. The device of claim 1, wherein the predicting the relative ability to interact with content of the individual comprises
receiving the information about activities of the individual from a plurality of client devices associated with the individual;
assigning a respective weight to respective information about the activities of the individual, wherein the respective weight is determined based on a respective client device of the plurality of client devices from which the respective information is received, forming weighted user activity information; and
computing a weighted average of the information about activities of the individual according to the weighted user activity information.

4. The device of claim 1, wherein the operations further comprise:
based on the ability to interact with content of the individual exceeding the predetermined interaction threshold, communicating with an advertising server to select an advertisement to present to the individual at a current time.

5. The device of claim 1, wherein the operations further comprise:
based on the ability to interact with content of the individual exceeding the predetermined interaction threshold, selecting an advertisement to present to the individual at a current time; and
based on the information about activities of the individual, selecting a delivery mode for presenting the advertisement to the individual at the current time.

6. The device of claim 5, wherein the operations further comprise:
based on the information about activities of the individual, identifying an application in current use by the individual on the client device; and
selecting an advertisement suitable for presentation through the application in current use.

7. The device of claim 1, wherein the operations further comprise:
based on the ability to interact with content of the individual exceeding the predetermined interaction threshold and the ability to interact with content of the individual not exceeding a second predetermined interaction threshold, selecting an advertisement to present to the individual at a future time.

8. The device of claim 1, wherein the operations further comprise:
based on the ability to interact with content of the individual exceeding the predetermined interaction threshold, selecting one of a message addressed to the individual or the client device, an information feed, a social media feed, or any combination thereof, to present to the individual; and
based on the ability to interact with content of the individual, selecting a presentation time.

9. A method, comprising:
receiving, by a processing system including a processor, information about current and future activities of an individual associated with a client device associated with the individual;
determining, by the processing system, a current ability to interact with content and a future ability to interact with content for the individual, wherein the determining is based on the information about current and future activities of the individual;
determining, by the processing system, an item of information to present to the individual at a client device associated with the individual, wherein the determining the item of information is based on the information about current and future activities of the individual;
determining, by the processing system, a preferred time to present the item of information to the individual, wherein the determining the preferred time is based on the information about current and future activities of the individual;
determining, by the processing system, a preferred mode to present the item of information to the individual, wherein the determining the preferred mode is based on the information about current and future activities of the individual and wherein the preferred mode is selected from one of a text message, an electronic mail message, video content, audio content, a display advertisement and a video advertisement;
receiving, by the processing system, from the client device associated with the individual according to user input from the individual, one or more delivery rules to override presentation of information including the item of information at the client device and to specify a mode for providing the item of information at the client device;
responsive to the one or more delivery rules, deferring presentation of information including the item of information to the client device;
responsive to the one or more delivery rules, forming a schedule including a scheduled time for subsequent delivery of information to the client device following the deferring presentation according to the one or more delivery rules;
responsive to the one or more delivery rules, selecting a different mode for providing the item of information to the individual; and
communicating, by the processing system, information about the item of information, the scheduled time and the different mode to a server for communication of the item of information to the client device associated with the individual.

10. The method of claim 9, further comprising:
determining, by the processing system, a current interaction score for the individual, wherein the determining the current interaction score is based on the information about current and future activities of the individual;
comparing, by the processing system, the current interaction score to a predetermined interaction threshold for the individual; and
selecting, by the processing system, an advertisement for the individual, wherein the selecting is based on the current interaction score exceeding the predetermined interaction threshold for the individual.

11. The method of claim 10, further comprising:
receiving, by the processing system, information about historical activity of the individual;
weighting, by the processing system, the information about historical activity of the individual according to a first weighting factor, forming weighted historical data;
weighting, by the processing system, the information about current and future activities of the individual according to a second weighting factor, forming weighted current data;
determining, by the processing system, a weighted average value based on the weighted historical data and the weighted current data; and
determining, by the processing system, the current interaction score for the individual based on the weighted average value.

12. The method of claim 11, further comprising:
determining, by the processing system, the preferred mode to present the item of information to the individual based on the current relative interaction score for the individual.

13. The method of claim 12, further comprising:
determining, by the processing system, a video advertisement as the preferred mode based on the current interaction score for the individual having a relatively high value.

14. The method of claim 12, further comprising:
determining, by the processing system, an electronic mail advertisement as the preferred mode based on the current interaction score for the individual having a relatively low value.

15. The method of claim 9, further comprising:
determining, by the processing system, a predicted duration of the current ability to interact with content, wherein the determining the predicted duration is based on the information about current and future activities of the individual.

16. The method of claim 9, wherein receiving information about current and future activities of an individual associated with a client device comprises:
receiving, by the processing system, as the information about current and future activities of the individual, calendar data of the individual, location data, activity data, or a combination of these; and
receiving, by the processing system, as the information about current and future activities of the individual, information from a mobile device of the individual, a smart speaker of the individual, a networked appliance of the individual, or a combination of these.

17. A non-transitory machine-readable medium, comprising executable instructions that, when executed by a processing system including a processor, facilitate performance of operations, the operations comprising:
storing information about location and activities of an individual, the information based on a usage of one or more client devices by the individual;
predicting, based on the stored information about location and activities of the individual, an ability to interact with content for the individual, wherein the ability to interact with content corresponds to an ability of the individual to receive and interact with information to be presented to the individual through the one or more client devices;
based on the ability to interact with content, selecting an item of information, selecting a presentation time and selecting a presentation mode for presenting the item of information to the individual, wherein the selecting a presentation mode comprises selecting the presentation mode from one of a text message, an electronic mail message, video content, audio content, a display advertisement and a video advertisement;
receiving, from a client device of the one or more client devices according to user input from the individual, one or more delivery rules to override presentation of information including the item of information at the one or more client devices and to specify a mode for presenting information;
responsive to the one or more delivery rules, deferring presentation of information including the item of information to the one or more client devices;
responsive to the one or more delivery rules, forming a schedule for subsequent delivery of information including the item of information to the one or more client devices following the deferring presentation according to the one or more delivery rules;
responsive to the one or more delivery rules, selecting a different mode for providing the item of information to the individual; and
communicating information about the item of information, the presentation time and the presentation mode to the one or more client devices to control presentation of the item of information to the individual.

18. The non-transitory machine-readable medium of claim 17, wherein the communicating information about the item of information comprises communicating the information about the item of information for combination by the one or more client devices with user delivery rules for controlling presentation of the item of information to the individual.

19. The non-transitory machine-readable medium of claim 17, wherein the operations further comprise:
receiving the information about location and activities of an individual from a plurality of client devices of the individual;
for each respective client device of the plurality of client devices, assigning a respective weight to the information about location and activities of the individual received from the respective client device, forming weighted user activity information, wherein information about location and activities of the individual received from wearable client devices is weighted higher than information about location and activities of the individual received from non-wearable client devices;
computing a weighted average value of the information about location and activities of an individual based the weighted user activity information; and
comparing the weighted average value to a predetermined interaction threshold to predict the ability to interact with content of the individual.

20. The non-transitory machine-readable medium of claim 19, wherein the operations further comprise:
based on the ability to interact with content of the individual exceeding the predetermined interaction threshold, selecting one of an advertisement, a message addressed to the individual, an information feed, a social media feed, or any combination thereof, as the item of information to present to the individual; and
based on the ability to interact with content of the individual, selecting the presentation time.
